(19) United States
(12) Patent Application Publication
(10) Pub. No.: US 2016/0330239 A1
(43) Pub. Date: Nov. 10, 2016

(54) HACKING PREVENTION SYSTEM FOR MOBILE TERMINAL AND METHOD THEREFOR

(71) Applicant: NPCORE, INC., Seoul (KR)

(72) Inventors: Seung Chul HAN, Seoul (KR); Young Hwan PARK, Seoul (KR)

(21) Appl. No.: 15/109,294

(22) PCT Filed: Jan. 14, 2014
(86) PCT No.: PCT/KR2014/000390

§ 371 Date: Jun. 30, 2016

(30) Foreign Application Priority Data
Jan. 13, 2014 (KR) 10-2014-0004012

(51) Int. Cl. H04L 29/06; H04W 12/12

(52) U.S. Cl. CPC H04L 63/1483; H04W 12/12

(57) ABSTRACT

The present invention is for preventing a mobile terminal from being hacked and relates to a system and method for identifying whether link information is safe. A system including a mobile terminal and an external server capable of being connected to the mobile terminal comprises: a mobile terminal for, when a web connection for any web site has been selected, extracting link information on the web site to transmit the link information to the external server, receiving a result of performing the web connection from the external server, and outputting the result; and an external server for, when the link information has been received, performing a web connection according to the link information using a preconfigured virtual execution means, and transmitting a result obtained by performing the web connection to the mobile terminal in response to the link information transmission.

### TECHNICAL FIELD

The present disclosure relates to a technique for preventing a mobile terminal hacking, and more particularly to a system and method for identifying whether link information is secure or not.

### BACKGROUND ART

Current mobile terminals may access web sites by using various access means such as Wireless Local Area Network (WLAN) (WIFI; Wireless Fidelity). Also, a user may obtain desired information by accessing and searching a desired web site, or download necessary data to a mobile terminal of the user. Furthermore, the user may directly access a desired web site by using link information which the user already knows.

However, there is a problem that it cannot be correctly identified what web site is accessed by the link information before actually accessing a web site through the link information. That is, a current user can identify a web site by using only information provided by an entity transmitting the link information. Alternatively, without need to identify a web site corresponding to the link information, the user can only receive data transmitted from the web site which can be accessed through the link information or automatically install a specific application in the mobile terminal through the web site.

Therefore, malicious hacking techniques using such the characteristics of the link information are being introduced. For example, according to known hacking techniques such as Smishing, Pharming, etc., a hacker may transmit link information of a fake web site (in the case of Smishing) or link information of a hacked domain web site (in the case of Pharming) to a user, and the user may access the fake web site or the hacked web site so that malicious codes or a malicious application may be installed in a mobile terminal of the user, or privacy information inputted by the user can be swindled through the malicious codes or application.

Therefore, methods for preventing damages of the above-described malicious hacking techniques, without impeding the convenience of using the link information, are being studied briskly.

### DISCLOSURE

### Technical Problem

The purpose of the present invention for resolving the above-described problem is to provide, when link information for accessing a web site is given, a system and method for preventing damages due to hacking by identifying whether a web site corresponding to link information is secure or not in advance.

### Technical Solution

In order to achieve the above-described purpose, a hacking prevention system for mobile terminals according to an exemplary embodiment of the present invention, as a system including a mobile terminal and an external server capable of being connected to the mobile terminal, may comprise a mobile terminal for, when a web connection for any web site has been selected, extracting link information on the web site to transmit the link information to the external server, receiving a result of performing the web connection from the external server, and outputting the result; and an external server for, when the link information has been received, performing a web connection according to the link information using a preconfigured virtual execution means, and transmitting the result of performing the web connection to the mobile terminal in response to the link information transmission.

In an exemplary embodiment, the result of performing the web connection may include at least one of information on a home page screen of the web site corresponding to the link information, and reputation information on the web site corresponding to the link information.

In an exemplary embodiment, the external server may detect a malicious behavior of an application installed as a result of the web connection, and perform analysis on the detected malicious behavior when the web connection according to the link information is performed, and the external sever may transmit the result of performing the web connection which further includes information on the application and a result of the analysis on the detected malicious behavior of the application.

In an exemplary embodiment, the mobile terminal may restrict a wireless access to the web site corresponding to the link information when the link information is transmitted to the external server, and access the web site corresponding to the link information according to selection of a user after the result of performing the web connection is received from the external server.

In an exemplary embodiment, the link information on the web site may be included in at least one of a message which the mobile terminal receives from external, screen information provided by a web site accessed by the mobile terminal, and data received from external for updating or driving one of applications installed in the mobile terminal.

In an exemplary embodiment, the mobile terminal nay encrypt the extracted link information by using unique information of the mobile terminal through a preconfigured encryption algorithm, and the external server may decrypt the encrypted link information by using the unique information of the mobile terminal when the encrypted link information is received.

In an exemplary embodiment, the external server may identify a service which a user of the mobile terminal subscribes according to unique information of the mobile terminal, and perform the web connection according to the link information by using a virtual execution means corresponding to the identified service.

Also, in order to achieve the above-described purpose, a hacking prevention method for mobile terminals according to an exemplary embodiment of the present invention, as a method for preventing a mobile terminal hacking in a system including the mobile terminal and an external server capable of being connected to the mobile terminal, may comprise extracting, by the mobile terminal, link information corresponding to the web site and transmitting the link information to the external server, when the mobile terminal tries a web connection to a web site; receiving, by the external server, the link information, and performing a web connection according to the received link information by using a virtual execution means; analyzing, by the external server, a result of performing the web connection, and transmitting the result to the mobile terminal; and receiving, by the mobile terminal, a result of the analysis, and displaying the result of the analysis.

In an exemplary embodiment, the link information on the web site may be included in at least one of a message which the mobile terminal receives from external, screen information provided by a web site accessed by the mobile terminal, and data received from external for updating or driving one of applications installed in the mobile terminal.

In an exemplary embodiment, the performing a web connection by using a virtual execution means further includes: selecting a virtual execution means corresponding to a service subscribed by a user of the mobile terminal; and performing the web connection through the selected virtual execution means.

In an exemplary embodiment, the result of performing the web connection may include at least one of information on a home page screen of the web site corresponding to the link information, and reputation information on the web site corresponding to the link information.

In an exemplary embodiment, the analyzing a result of performing the web connection and transmitting the result to the mobile terminal may further include: detecting an application installed as a result of the web connection according to the link information; when the application is detected, detecting a malicious behavior of the application; analyzing the detected malicious behavior; and transmitting a result of detecting the application, and a result of analyzing the detected malicious behavior to the mobile terminal.

In an exemplary embodiment, the extracting link information corresponding to the web site and transmitting the link information to the external server may further include: encrypting the link information by using preconfigured cipher information; and transmitting the encrypted link information to the external server.

### Advantageous Effects

Therefore, according to the present invention, it can be identified in advance whether a web site, which can be accessed by using link information, is malicious or not, before actually accessing a web site. Thus, a damage caused by accessing a fake web site through the link information can be prevented.

Also, according to the present invention, the web site can be accessed by a virtual platform through the link information, and a result of accessing the web site can be transmitted to the mobile terminal, so that the mobile terminal can be protected from a latent hacking risk which can be realized by the link information.

### DESCRIPTION OF DRAWINGS

FIG. 1 is a view to illustrate a configuration of a hacking prevention system for a mobile terminal according to an exemplary embodiment of the present invention.

FIG. 2 is a view to illustrate a detail configuration of a mobile terminal and a server connected to the mobile terminal in a hacking prevention system according to an exemplary embodiment of the present invention.

FIG. 3 is a view to illustrate an operation flow of a mobile terminal and a server in the hacking prevention system according to an exemplary embodiment of the present invention.

FIG. 4 is a view to illustrate an example of a screen displayed in the mobile terminal according to the operation flow illustrated in FIG. 3.

FIG. 5 is a view to illustrate an example, in which various screens including results of analysis on link information are displayed in a mobile terminal, according to an exemplary embodiment of the present invention.

FIG. 6 is a view to illustrate an example of an encryption and authentication procedure for protection of privacy information in a hacking prevention system according to the present invention.

FIG. 7 is a view to illustrate various examples of link information which can be analyzed in a hacking prevention system according to an exemplary embodiment of the present invention.

### BEST MODE

The terminology used herein is for the purpose of describing particular embodiments only and is not intended to be limiting. Also, the singular forms are intended to include the plural forms as well, unless the context clearly indicates otherwise. It will be further understood that the terms “comprises” or “includes”, when used herein, do not preclude the presence or addition of one or more other features, steps, operations, elements, components, and/or groups thereof.

Also, in describing the present disclosure, if a detailed explanation for a related known function or construction is considered to unnecessarily divert the gist of the present disclosure, such explanation has been omitted but may be understood by those skilled in the art.

Hereinafter, exemplary embodiments according the present disclosure will be explained in detail by referring accompanying figures. The term ‘link information’, which is used through the present disclosure, may mean access information used for accessing a specific web site. Also, such the link information may have a form of a domain address (e.g. a form of “http://”). In addition, the link information may have a form of a pop-up window, an icon, etc. corresponding to the domain address.

Also, the term ‘behavior analysis’, which is used through the present disclosure, may mean analysis on, when a web connection is performed using the link information, data downloaded from the accessed web site, tasks performed by an application which is automatically installed from the accessed web site, and effects incurred by the tasks.

For complete understanding of the present invention, a fundamental concept of the present invention can be explained as follows. In the present invention, when a mobile terminal tries to access a web site by using link information, the mobile terminal transmits the link information to a predetermined server. Also, the service having received the link information may access the web site corresponding to the link information by using a virtual platform, and analyze a connection status of the web site and effects according to accessing the web site. For example, the server may identify whether an application, which is automatically installed due to the access to the web site, exists or not through the virtual platform. If such the application exists, the server may analyze tasks that the application performs or tries to perform and effects of the tasks through the behavior analysis on the application. In addition, the server may transmit the analysis result to the mobile terminal, and the mobile terminal may identify the analysis result so as to decide whether to access the web site corresponding to the link information.

Therefore, in the present invention, effects of a specific web site may be identified before a mobile terminal actually accesses the specific web site by using link information, and thus link information having malicious intention can be identified, so that trials of hacking of the mobile terminal can be prevented beforehand.

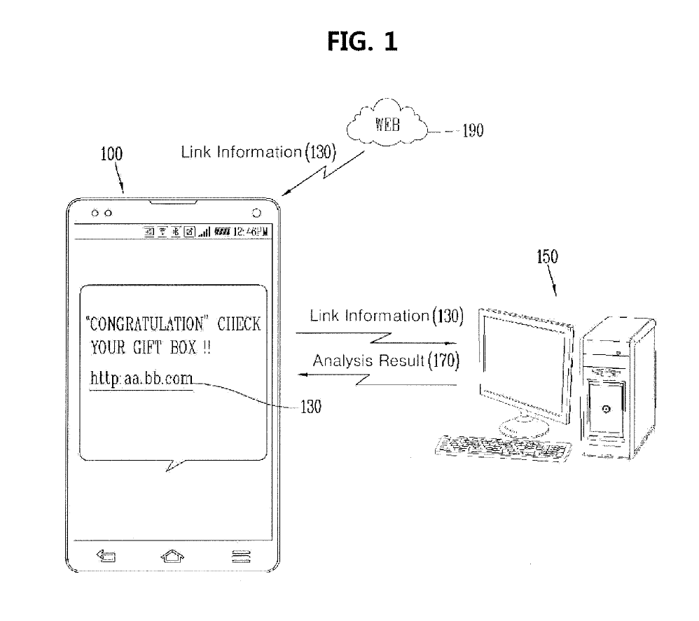

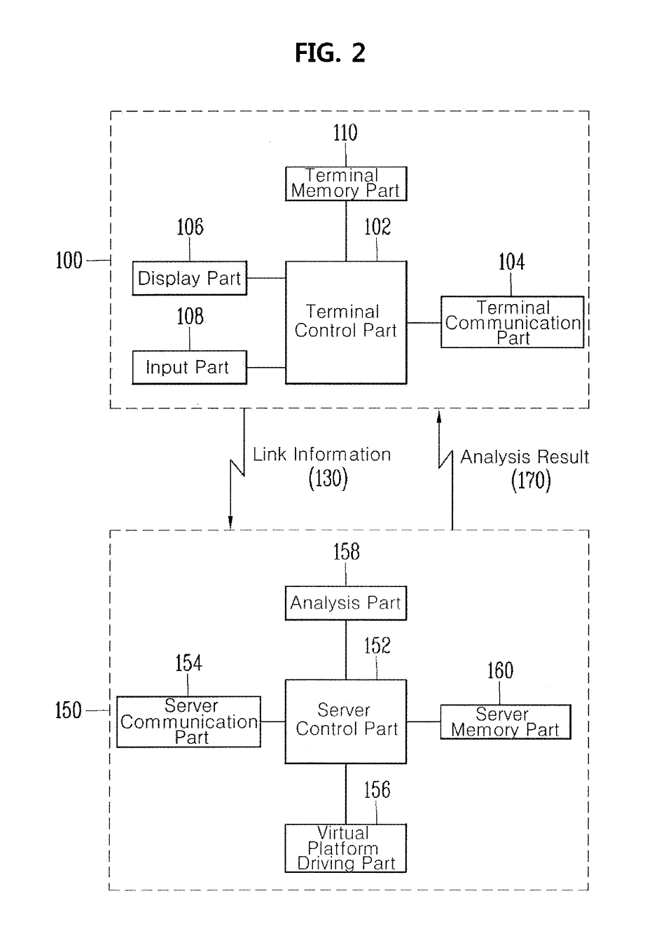

FIG. 1 is a view to illustrate a configuration of a hacking prevention system for a mobile terminal according to an exemplary embodiment of the present invention. Also, FIG. 2 is a view to illustrate a detail configuration of a mobile terminal and a server connected to the mobile terminal in a hacking prevention system according to an exemplary embodiment of the present invention.

Referring to FIG. 1, a hacking prevention system according to an exemplary embodiment of the present invention may be configured to comprise a mobile terminal 100, which transmits link information 130 to a preconfigured virtual server 150 when a connection to a web site is tried according to the link information 130, and the server 150, which receives the link information from the mobile terminal 100 and perform a virtual connection to the web site according to the received link information.

The mobile terminal 100 may receive the link information 130 having various formats from a web 190. For example, the link information 130 may be transmitted to the terminal 100 as included in a text message (e.g. short message service (SMS) message), as illustrated in FIG. 1. Also, the link information may be included in screen information provided by a page of a web site which the mobile terminal 100 accesses currently.

In a case that a connection to a web site according to the link information 130 is desired by a user, the mobile terminal 100 may transmit the link information 130 to the server 150. Such the mobile terminal 100 may be configured to comprise a terminal control part 102, a terminal communication part 104 connected to the mobile control part 102, a display part 106, an input part 108, and a terminal memory part 110.

Here, the terminal communication part 104 may transmit and receive radio signals with at least one of a base station, another terminal, and a server, in a mobile communication network. The radio signals may include voice call signal, video call signal, or various types of data for text/multimedia message transmission/reception. Also, such the data may include the link information having various formats.

The terminal communication part 140 may be configured to implement a video call mode or a voice call mode. The video call mode is a communication mode in which a video signal of a counterpart terminal is provided, and the voice call mode is a communication mode in which only a voice signal of a counterpart terminal is provided. In order to implement the video call mode and the voice call mode, the mobile communication module 1120 may be configured to receive at least one of the video signal and the voice signal.

The terminal communication part 104 may include a module for wireless internet access, and may be embedded in the mobile terminal 100, or may exist externally from the mobile terminal 100. A technology for the wireless internet access may include WLAN (wireless LAN; Wi-Fi), Wireless Broadband (WiBro), World Interoperability for Microwave Access (WiMax), or High Speed Downlink Packet Access (HSDPA).

Also, the display part 106 may display (output) information processed by the mobile terminal 100. For example, when the mobile terminal 100 is in a call mode, a user interface (UI) or a graphic user interface (GUI) related to the call may be displayed through the display part 106. When the mobile terminal 100 is in the video call mode or a photograph mode, the display part 106 may display video signals, which are captured and/or received, or the UI and GUI.

Also, the terminal memory part 110 may store programs for operations of the terminal control part 102, and temporarily store inputted data and data to be outputted (e.g. data for a phonebook, messages, still images, video data, etc.). Also, the terminal memory part 110 may store data for vibrations and sound effects having various patterns, which are outputted when touch-inputs are given to a touch screen.

Also, the terminal memory part 110 may store various programs used for the mobile terminal 100 to perform wireless internet accesses through the mobile communication part 104. While the mobile terminal 100 is performing wireless internet accesses, the terminal memory part 110 may store various data received from accessed web sites. For example, information, in which link information corresponding to a specific web site is included, may be stored in the terminal memory part 110 as included in a SMS message or a Multimedia Message Service (MMS) message.

Also, the terminal memory part 110 may further store authentication information which may be requested by the server 150 or data for decrypting encrypted data.

In addition, the terminal memory part 110 may further store various programs or information needed for encrypting data.

Also, the terminal control part 102 may control overall operations of the mobile terminal 100. For example, it may perform controls and processes related to voice calls, data communications, video calls, etc. Also, according to a user's selection, an access to a specific web site through wireless internet may be performed. For example, in order to access a specific web site, the user may directly input a domain address of the specific web site or select a specific region corresponding to the specific web site in a screen on which a currently-accessed web site page is displayed. Alternatively, when specific link information is selected, the terminal control part 102 may access a web site corresponding to the selected link information.

Also, the input part 108 may receive key inputs according to the user's selection. For example, the input part 108 may be configured to comprise a touch screen, and when a touch input of the user exists in the display part 106, the touch input may be detected. Also, an address of a specific web site may be configured according to the user's key inputs, or specific link information may he selected according to the user's selection.

Meanwhile, before accessing the specific web site, the terminal control part 102 may transmit link information corresponding to the specific web site to the server 150. For example, in the case that the user directly inputs the domain address of the specific web site, the inputted domain address may be transmitted to the server 150. In the case that the user selects a specific region of a screen in which the web site is displayed, link information corresponding to the selected specific region may be transmitted to the server 150. Also, if the user receives data including link information for accessing a specific web site from an external entity, and selects the link information included in the received data, the mobile control part 102 may transmit the selected link information to the server 150.

The terminal control part 102 may restrict an access to the specific web site based on the link information, until an analysis result on the link information transmitted to the server 150. Then, after the analysis result is received from the server 150, the terminal control part 102 may display the result in the display part 106. After displaying the analysis result in the display part 106, the terminal control part 102 may continue the access to the specific web site according to the user's selection.

Meanwhile, when the link information 130 is received from the mobile terminal 100, the server 150 may try to access the web site corresponding to the received link information 130 through virtual execution means, for example, a virtual platform. Then, when an application which is to be automatically installed by the web site corresponding to the link information, the server 150 may install the application in the virtual platform, and analyze behaviors of the installed application. For example, the server 150 may perform analysis on tasks performed by the application, analysis on which data the application requests to the virtual platform, analysis on which data are read out by the application, or analysis on which task the application performs by using the read-out data. Also, the server 150 may analyze codes of the installed application, and determine whether the application includes malicious execution codes or not.

Here, a different virtual platform, in which the application is installed, may be selected according to a service subscribed by the user of the mobile terminal 100 having transmitted the link information 130. For example, a virtual platform provided by the server may be classified into a shared platform and a dedicated platform. The shared platform may be used by a plurality of users subscribing normal services, and the dedicated platform may be used by a user subscribing a high-grade service (e.g. a charged service or a premium service). Also, the difference between the dedicated platform and the shared platform may be, for example, whether to protect privacy information of the user.

For example, the shared platform may be used by any one of normal users. However, since the shared platform is used by a plurality of users, encryption services may not be provided, or the number of simultaneously-connected users may be restricted. However, the dedicated platform may be provided to a user as a personal virtual platform, and encryption functions on information exchanged between the server 150 and the mobile terminal 100 may be provided. Thus, the dedicated platform may prevent privacy information leakage.

In addition, the virtual platform may be classified according to its feature and performance. For example, the virtual platform may have only a function of simply accessing a web site corresponding to link information. Additionally or alternatively, the virtual platform may have a function of providing user reputation information on the web site corresponding to the link information, such that the user can determine whether the web site corresponding to the link information is malicious or not based on the provided user reputation information. Additionally or alternatively, the virtual platform may have a function of installing an application transmitted from the web site corresponding to the link information, and analyzing codes of the installed application or behaviors of the installed application.

Such the virtual platform may be determined according to a service selected by a user. For example, when the server 150 receives the link information 130, the server 150 may identify a service selected by the user based on subscriber information of the mobile terminal 100. Also, the server 150 may select one of virtual platforms having various functions and performances according to the service selected by the user.

For example, the server 150 may select, for a free user, the virtual platform having only the function of simply accessing the web site corresponding to the received link information, and transmit information related to a screen of the web site accessed according to the received link information to the mobile terminal 100, as an analysis result 170 for the link information. Meanwhile, for a charged user, the server 150 may transmit, to the mobile terminal 100, other users' reputation information on the web site accessed according to the link information and analysis results on the behaviors of the application installed from the web site, as well as the information related to the screen of the web site accessed according to the link information.

The server 150 may be configured to comprise a server control part 152, a server communication part 154 connected to the server control part 152, a server memory part 160, an analysis part 158, and a virtual platform driving part 156.

Here, the server communication part 154 may be connected to the mobile terminal 100 via a predetermined mobile communication manner. Also, the server communication part 154 may receive the link information 130 from the mobile terminal 100, and access a web site corresponding to the received link information, under control of the server control part 152.

The server memory part 160 may store various programs and data needed for operations of the server. The server memory part 160 may store data for driving at least one virtual platform, and supply necessary data according to control of the server control part 152 so as to drive the at least one virtual platform.

Also, the server memory part 160 may further store information on services subscribed by users. For example, the server memory part 160 may store information on services subscribed by respective users.

Meanwhile, when the link information 130 is received as encrypted, the server memory part 160 may store data needed for decrypting the encrypted link information. Also, when the analysis result 170 corresponding to the link information 130 is transmitted from the server 150, the server memory part 160 may further store encryption information needed for encrypting the analysis result.

Also, the virtual platform driving part 156 mat select a virtual platform according to control of the server control part 152, and try to access a web site corresponding to the received link information through the selected virtual platform. The virtual platform driving part 156 may have a plurality of virtual platforms. For example, the virtual platform driving part 156 may have various different virtual platforms according to versions of operating systems (OS) of the mobile terminal 100 and hardware types of the mobile terminal 100, and drive at least one virtual platform according to control of the server control part 152.

Also, the server control part 152 may control respective components. When the link information 130 is received, the server control part 152 may select a virtual platform to access the web site corresponding to the link information 130. For example, the server control part 152 may receive information on an OS version of the mobile terminal 100 transmitting the link information 130, and make the virtual platform driving part 156 select a virtual platform having an OS with the same version. Additionally or alternatively, the server control part 152 may make the platform driving part 156 select a virtual platform according to the hardware type of the mobile terminal 100 transmitting the link information 130. Additionally or alternatively, the server control part 152 may make the platform driving part 156 select a virtual platform according to a service subscribed by the user by identifying subscription information of the user, which is included in the link information 130.

Once the virtual platform is selected, the server control part 152 may control the virtual platform driving part 156 to access the web site corresponding to the link information 130 through the selected virtual platform. Also, through the analysis part 158, the server control part 152 may analyze results and effects caused by accessing the web site.

For example, the analysis part 158 may detect whether an application which is automatically installed through the accessed web site exists or not. If such the application exists, the analysis part 158 may identify whether the application does malicious behaviors or not through analysis on behaviors of the application. For example, the analysis part 158 may determine whether the application is malicious or not according to type and property of data which the application reads out from the virtual platform. Also, the analysis part 158 may determine that the application is malicious when the application substitute or delete specific data without permission. As described above, the analysis part 158 may analyze behaviors of the application installed from the accessed web site, and transmit the analysis results to the server control part 152.

After completion of the analysis of the analysis part 158, the server control part 152 may transmit the analysis result to mobile terminal 100 through the server communication part 154. Here, the server control part 152 may transmit the analysis result as encrypted.

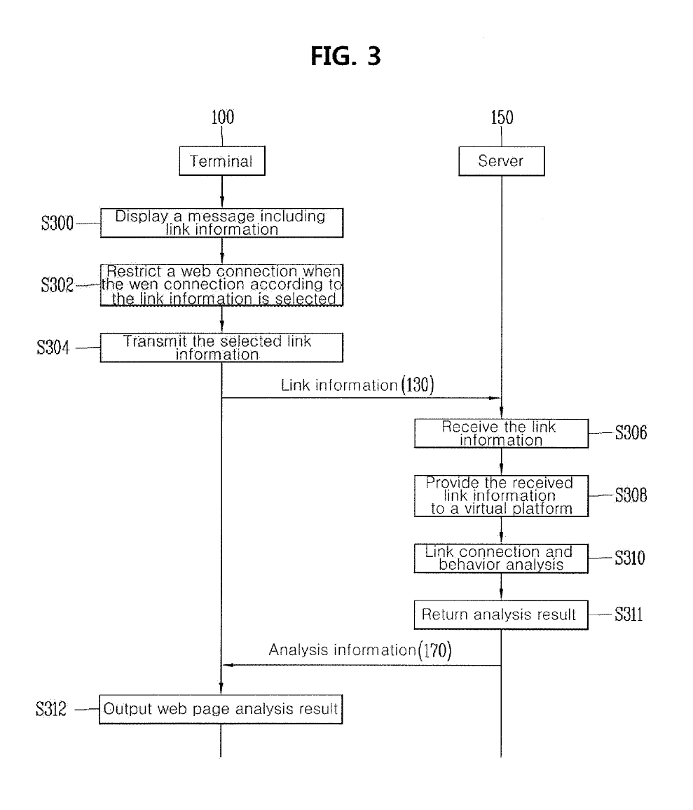

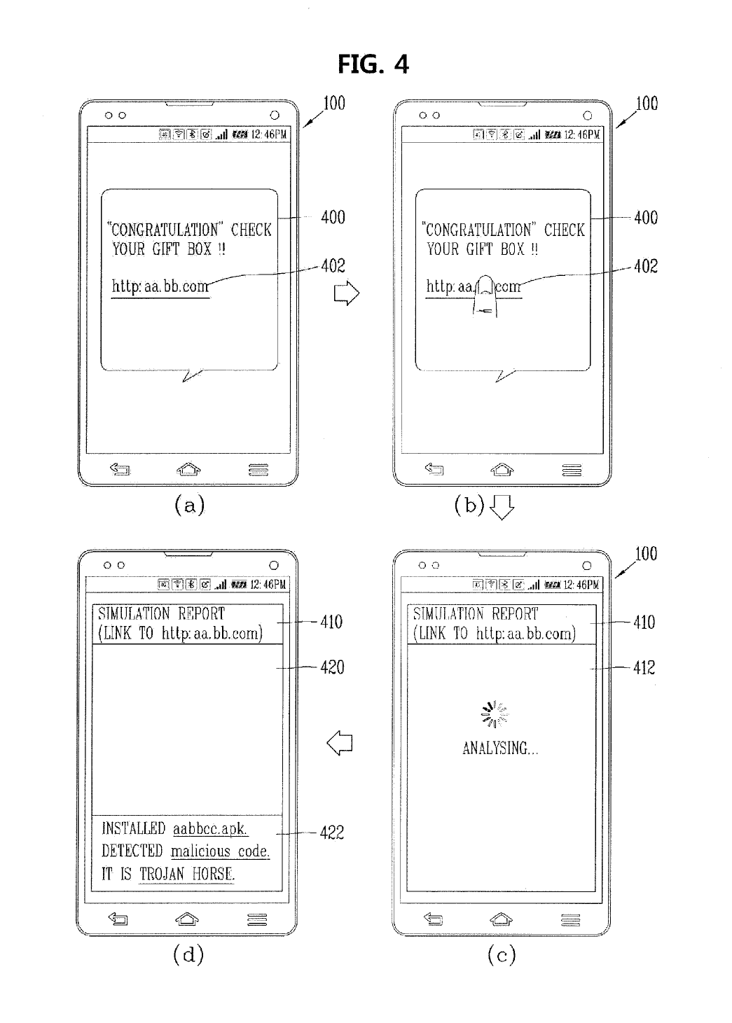

FIG. 3 is a view to illustrate an operation flow of a mobile terminal and a server in the hacking prevention system according to an exemplary embodiment of the present invention. Also, FIG. 4 is a view to illustrate an example of a screen displayed in the mobile terminal according to the operation flow illustrated in FIG. 3.

For example, in a case that a user selects a message 400 including link information 402 in a received message, the terminal control part 102 may display the message 400 in the display part 106 as illustrated in (a) of FIG. 4. In this case, the terminal control part 102 may check whether the user selected the link information 402 correctly or not.

Also, in a case that the user selects the link information 402 as illustrated in (b) of FIG. 4, the terminal control part 402 may restrict a direct web connection to a web site according to the selected link information 402 (S302). For example, even when the link information 402 is selected, the terminal control part 102 may represent a fact that the server 150 is analyzing the link information 402 (410, 412), as illustrated in (c) of FIG. 4, and restrict the web connection until an analysis result is received from the server. This is for preventing the unsicker web connection without checking the web site corresponding to the link information 402. However, this may be changed according to the user's configuration. That is, the web connection may not be restricted according to the user's configuration. Also, the terminal control part 102 may perform other functions except the web connection until the analysis result is received.

Meanwhile, in the step 5302, when the link information 130 is selected by the user, the terminal control part 102 may transmit the selected link information 130 to the server 150 (S304). The link information 402 may be transmitted to the server 150 through a predetermined transmission means such as a near-distance communication means (e.g. an infrared data association (IrDA), a Bluetooth, etc.) and a wireless internet access (e.g. WIFI, etc.).

The server 150 may receive the link information 130 (S306). Then, the server control part 152 may select a virtual platform according to a hardware type, an OS version, or a service subscribed by the user of the mobile terminal 100 having transmitted the link information 130. Then, the server control part 150 may provide the received link information to the selected virtual platform (S308).

When the link information is provide to the virtual platform, the server control part 152 may control the virtual platform driving part 156 to perform an access to the web site according to the link information. Also, the server control part 152 may analyze a result of accessing the web site. The server control part 152 may detect whether an application which is installed from the accessed web site exists or not, and behaviors of the detected application (S310).

When the link information is provided to the virtual platform, the server control part 152 may control the virtual platform driving part 156 to perform the access to the web site corresponding to the provided link information. Then, the server control part 152 may analyze a result of the access to the web site. The server control part 152 may detect whether an application installed from the accessed web site, and analyze behaviors of the detected application (S310).

Then, after completion of the access to the web site and the analysis of the behaviors, the server control part 152 may transmit the analysis result 170 to the mobile terminal 100. Here, the analysis result 170 may be screen information of the accessed web site corresponding to the link formation, or may include reputation information on whether the web site is a malicious web site or not, which was evaluated by other users. Here, the malicious web site may mean a web site constructed with malicious intentions such as a web site related to obscene materials or gambling, or a fake web site constructed for installing malignant codes or computer viruses. Also, as described above, the analysis result may include a result of analysis on the behaviors of the installed from the web site.

The mobile terminal 100 having received the analysis result 170 may display the analysis result 170 in the display part 106. For example, the terminal control part 102 may display the received analysis result 170 in at least part of a display screen of the display part 106, as illustrated in (d) of FIG. 4.

Also, the analysis result screen 412 may include a region 410 in which a fact that the link information 402 is being analyzed by the server is displayed, a region 420 in which the screen information provided by the web site accessed using the link information 402 is displayed, and a region 422 in which the automatically-installed application and the result of analysis on the behaviors of the application are displayed.

In addition, the terminal control part 102 may further check whether the user wants to actually access the web site corresponding to the link information 402 or not through the analysis result screen. For example, the terminal control part 102 may further display a selection screen used for the user to confirm the actual access to the web site in a part of the analysis result screen.

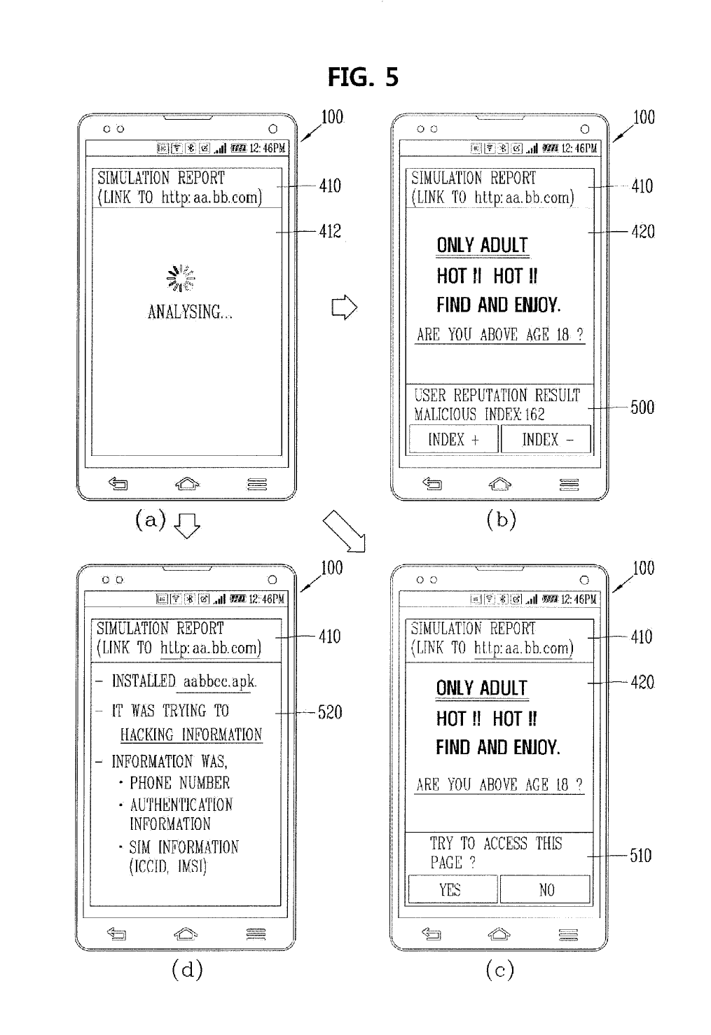

FIG. 5 is a view to illustrate an example, in which various screens including results of analysis on link information are displayed in a mobile terminal, according to an exemplary embodiment of the present invention.

Referring to FIG. 5, when the analysis result 170 is not received from the server 150, the link information 402 transmitted to the sever 150 may be displayed in the analysis result screen 412, as illustrated in (a) of FIG. 5. When the analysis result 170 is received from the server 150, the terminal control part 102 may display screen information of the accessed web site, as illustrated in (b) of FIG. 5. Also, the terminal control part 102 may display reputation information on the web site accessed by the server 150 through the virtual platform, which was evaluated by other users, in a part of a region in which the screen information is displayed.

Here, the reputation information, as described above, may mean information determined by a plurality of other users on whether the web site accessed by the server 150 is constructed with malicious intentions or not. For example, as illustrated in (b) of FIG. 5, the reputation information may be represented in a form of index. For example, as illustrated in (b) of FIG. 5, when a malicious index indicates 162, the user may identify that 162 users determined the corresponding web site as a web site constructed with malicious intentions.

Also, as illustrated in (b) of FIG. 5, if the user selects an increase of the index (e.g. ‘+’) or a decrease of the index (e.g. ‘−’), the value of the malicious index may change according to the selection of the user.

Meanwhile, the analysis result screen 412 may further include a menu screen used for the user to select whether to actually access the corresponding web site. For example, as illustrated in (b) of FIG. 5, the terminal control part 102 may display the menu screen 510 in at least part of the region in which the screen information 402 is displayed, and try to actually access the web site corresponding to the link information 402 based on the user selection on the menu screen 510.

Meanwhile, in the hacking prevention system according to an exemplary embodiment of the present invention, the display part 106 of the mobile terminal 100 may display, as illustrated in (b) and (c) of FIG. 5, screen information 420 of the web site accessed according to the link information 402. In addition, as illustrated in (d) of FIG. 5, further detail behavior analysis results 520 may be displayed by the display part 106.

Meanwhile, a web site constructed with malicious intentions may include, as illustrated in (b) or (c) of FIG. 5, a web site including obscene materials or a gambling web site. Also, the web site constructed with malicious intentions may include a web site installing malicious codes for smishing or pharming in the mobile terminal of the user. In the case that the website is for installing such the malicious codes in the mobile terminal, when the user access the web site by using the link information, the application including the malicious codes may be installed in the mobile terminal 100, and authentication information or privacy information of the user may be swindled through the installed malicious codes.

In the case of the above-described web site having the purpose of installing malicious codes in the mobile terminal 100, the analysis result 170 may include detail information on whether an application installed by the web site exists or not, behaviors tried by the application, and information which the application tried to swindle. Also, the analysis result 170 may be displayed in the display part 106, as illustrated in (d) of FIG. 5.

As illustrated in FIG. 5, the analysis result screen may be formed in various manners. Also, although examples of the analysis result screen are illustrated in (b), (c), or (d) of FIG. 5, an exemplary embodiment of the present invention is not restricted to the above examples.

That is, after the analysis result screen corresponding to (b), (c), or (d) of FIG. 5 is displayed, a screen including other information may be displayed according to selection of the user. Alternatively, information of at least one of (b), (c), and (d) of FIG. 5 may be displayed together in a single screen. For example, the terminal control part 102 may display the menu screen 510 used for the user to decide whether to actually access the current web site in the display part 106, together with the reputation information screen of other users 500.

Also, information included in the analysis result screen may change according to a service subscribed by the user. For example, the user subscribing a normal service or a free service may receive only reputation information of the web site accessed by the server 150, which is illustrated in (b) or (c) of FIG. 5. However, the user subscribing a premium service or a charged service may receive the result of analysis on behaviors of the application installed from the web site, which is illustrated in (d) of FIG. 5, in addition to the information of (b) or (c) of FIG. 5.

Accordingly, the virtual platform used for the user subscribing the normal service or the free service may be different from the virtual platform used for the user subscribing the charged service or the premium service. In other words, accessing the web site corresponding to the provided link information, detecting an automatically-installed application, and analyzing behaviors of the application may be performed simultaneously in the virtual platform for the charger service or the premium service.

Meanwhile, the mobile terminal and the server of the hacking prevention system according to the present invention may transmit the link information and the result of analysis on the web site corresponding to the link information as encrypted for protection of privacy information of the user.

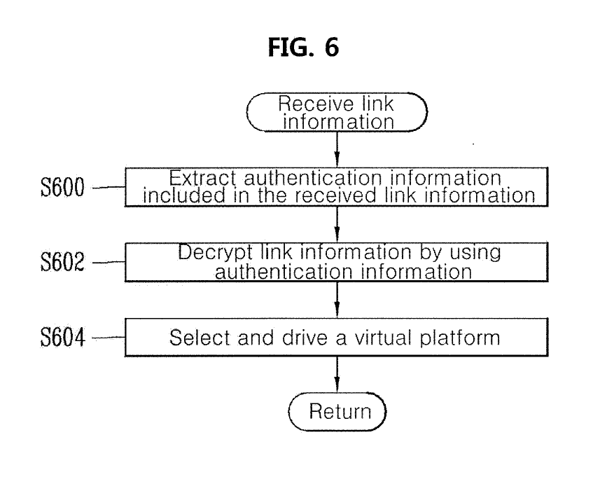

FIG. 6 is a view to illustrate an example of an encryption and authentication procedure for protection of privacy information in a hacking prevention system according to the present invention.

For example, in the step S304, the mobile terminal 100 may transmit the link information selected by the user to the server 150 as encrypted. Here, the mobile terminal 100 may use various encryption keys. For example, the mobile terminal 100 may encrypt the link information by using its subscriber information or preconfigured cipher information, and transmit the encrypted link information to the server 150.

Here, the link information 130 transmitted to the server may include the encrypted link information and the preconfigured cipher information. In this case, the serer control part 152 may extract the cipher information from the link information received through the server control part 154 (S600). Then, the server control part 152 may decrypt the link information by using the extracted cipher information (S602). Then, the server control part 152 may provide the decrypted link information to the selected virtual platform, and drive the virtual platform to analyze results of the access to the web site corresponding to the link information.

Meanwhile, the result of analysis on the web site may be transmitted to the mobile terminal 100 as encrypted. Here, the server 150 may encrypt the analysis result by using the cipher information included in the link information. Then, the terminal control part 102 receiving the encrypted analysis result may decrypt the encrypted analysis result by using the cipher information, and display the decrypted analysis result in the display part 106. Here, the cipher information may be a cipher preconfigured by the user, a telephone number of the user, etc. Also, the cipher information may be unique information or authentication information of the mobile terminal 100.

Also, although an example, in which only the link information and the analysis result are encrypted and decrypted according to the preconfigured information, is explained referring to FIG. 6, user authentication may be performed for the mobile terminal 100 to access the server 150, in addition to the encryption and decryption. For example, in a case of a dedicated virtual platform, the user may access the virtual platform by using access information of the user (e.g. identifier (ID) and password). After the dedicated virtual platform is accessed by the user, a secure channel may be formed between the mobile terminal 100 and the virtual platform so that the link information and the analysis result can be exchanged through the secure channel.

Meanwhile, in the above-described exemplary embodiment, an example, in which link information included in a message, etc. may be selected, the selected link information may be transmitted to the server 150, and a result of accessing a web site corresponding to the link information is analyzed by the server 150, was explained. However, the present invention is not restricted to the above example. However, the present invention is not restricted to the above example. For example, the present invention may also be applied to various types of link information which can be used in all cases for trying to access a web site, as well as the above-described type of link information included in the message.

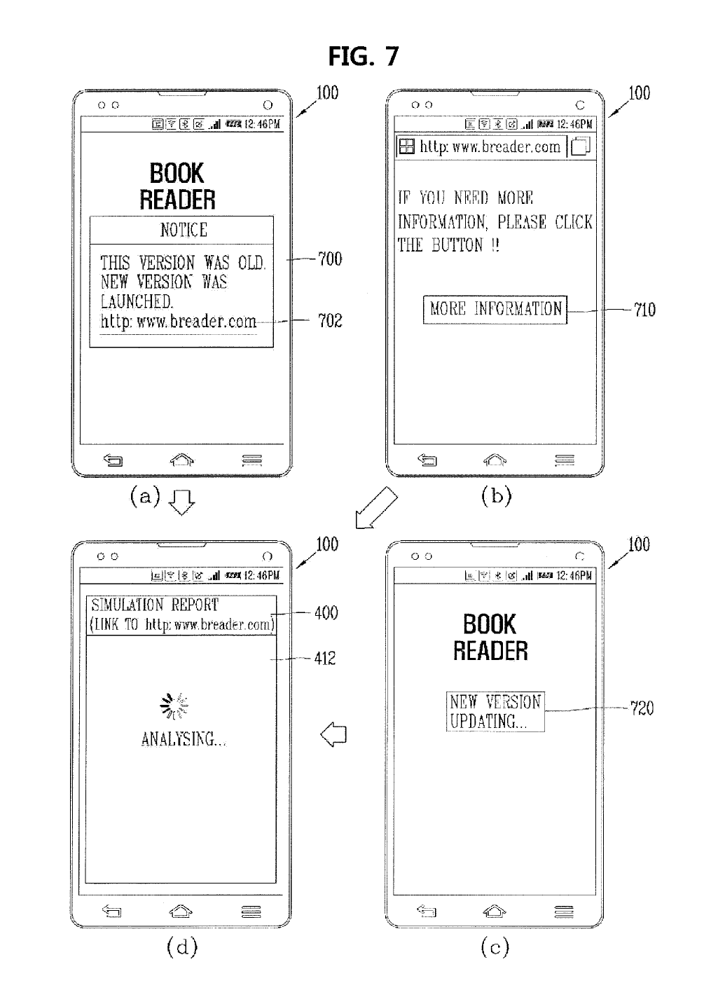

FIG. 7 is a view to illustrate various examples of link information which can be analyzed in a hacking prevention system according to an exemplary embodiment of the present invention.

For example, as illustrated in (a) of FIG. 7, when link information 702 included in a notice 700 provided by an application operating in the mobile terminal 100 is selected, that is, when a web connection according to the link information 702 included in an alarm message or the notice 700 provided by the application is tried, the mobile terminal 100 may transmit the link information 702 to the server 150 in order to identify a result of access using the link information 702.

Therefore, as illustrated in (d) of FIG. 7, the link information 702 included in the notice 700 may be transmitted to the server 150, and the virtual platform of the server 150 may access a web site by using the link information 702, and analyze a result of accessing the web site. Also, the analysis result may be transmitted to the mobile terminal 100. Thus, even a case, in which a web site constructed with malicious intentions tries to tempt the user to access the web site by using an alarm of a specific application, can be prevented in a hacking prevention system according to an exemplary embodiment of the present invention.

In addition, as illustrated in (b) of FIG. 7, the mobile terminal 100 of a hacking prevention system according to an exemplary embodiment of the present invention may be applied to a case in which a specific web site is accessed through screen information provided by a currently accessed web site. That is, as illustrated in (b) of FIG. 7, when the user selects a graphic object (e.g. an icon 710) for transitioning from the currently accessed web site to another web site, the mobile terminal 100 may transmit the link information corresponding to the graphic object 710 to the server 150. Then, the server 150 may analyze a result of accessing the web site corresponding to the link information, and transmit the analysis result to the mobile terminal 100.

Similarly to the above, the present invention may also be applied to a case in which a graphic object for controlling an application to access a specific web site is selected. For example, as illustrated in (c) of FIG. 7, the graphic object for accessing a specific web site may be an icon, etc. for receiving data from outside in order to update or drive the application. In this case, when the graphic object 720 is selected by the user, the mobile terminal 100 may transmit the link information corresponding to the graphic object 720 to the server 150, and the server 150 may analyze a result of accessing the web site corresponding to the link information. Then, the server 150 may transmit the result to the mobile terminal 100.

Meanwhile, in the hacking prevention system according to an exemplary embodiment of the present invention, when the mobile terminal 100 tries to access a web site, link information corresponding to the web site, which the mobile terminal tries to access, may be extracted and transmitted to the server 150, so that a result of accessing the web site is analyzed through the virtual platform. According to the present invention, the result of accessing the web site corresponding to the link information can be identified regardless of type of the link information.

Although the detailed exemplary embodiments according to the present invention were explained, various modifications may be added to the exemplary embodiments without departing from a scope of the present invention. Especially, according to the above-described exemplary embodiments, link information is extracted and analyzed when a mobile terminal tries to access a web. However, this may not be performed for all web connections.

For example, a user may specify a web site analysis on which is not necessary. Also, a web site determined as a safe web site may not be analyzed during a predetermined period. Also, the user may make analysis on a result of accessing a web site be performed selectively. For example, before the mobile terminal 100 extracts link information from a tried access to a web site and transmits the link information to the server 150, the use may decide whether to analyze a result of accessing the web site.

Alternatively, a result of accessing a web site may be analyzed in a specific case selected by the user. That is, the function of analyzing a result of accessing a web site may be turned on or turned off according to selection of the user. For example, such the function may be turned off temporarily, while the user is doing web surfing.

Those having ordinary knowledge in the technical field, to which the present invention pertains, will appreciate that various modifications and changes in form, such as combination, separation, substitution, and change of a configuration, are possible without departing from the essential features of the present invention. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A system including a mobile terminal and an external server capable of being connected to the mobile terminal, the system comprising:
a mobile terminal for, when a web connection for a web site has been selected, extracting link information on the web site to transmit the link information to the external server, receiving a result of performing the web connection from the external server, and outputting the result; and
an external server for, when the link information has been received, performing a web connection according to the link information using a preconfigured virtual execution means, and transmitting the result of performing the web connection to the mobile terminal in response to the link information transmission.

2. The system according to claim 1, wherein the result of performing the web connection includes at least one of information on a home page screen of the web site corresponding to the link information, and reputation information on the web site corresponding to the link information.

3. The system according to claim 2,
wherein the external server detects a malicious behavior of an application installed as a result of the web connection, and performs analysis on the detected malicious behavior when the web connection according to the link information is performed, and
wherein the external sever transmits the result of performing the web connection which further includes information on the application and a result of the analysis on the detected malicious behavior of the application.

4. The system according to claim 1, wherein the mobile terminal restricts a wireless access to the web site corresponding to the link information when the link information is transmitted to the external server, and accesses the web site corresponding to the link information according to selection of a user after the result of performing the web connection is received from the external server.

5. The system according to claim 1, wherein the link information on the web site is included in at least one of a message which the mobile terminal receives from external, screen information provided by a web site accessed by the mobile terminal, and data received from external for updating or driving one of applications installed in the mobile terminal.

6. The system according to claim 1, wherein the mobile terminal encrypts the extracted link information by using unique information of the mobile terminal through a preconfigured encryption algorithm, and the external server decrypts the encrypted link information by using the unique information of the mobile terminal when the encrypted link information is received.

7. The system according to claim 1, wherein the external server identifies a service which a user of the mobile terminal subscribes according to unique information of the mobile terminal, and performs the web connection according to the link information by using a virtual execution means corresponding to the identified service.

8. A method for preventing a mobile terminal hacking in a system including the mobile terminal and an external server capable of being connected to the mobile terminal, the method comprising:
extracting, by the mobile terminal, link information corresponding to the web site and transmitting the link information to the external server, when the mobile terminal tries a web connection to a web site;
receiving, by the external server, the link information, and performing a web connection according to the received link information by using a virtual execution means;
analyzing, by the external server, a result of performing the web connection, and transmitting the result to the mobile terminal; and
receiving, by the mobile terminal, a result of the analysis, and displaying the result of the analysis.

9. The method according to claim 8, wherein the link information on the web site is included in at least one of a message which the mobile terminal receives from external, screen information provided by a web site accessed by the mobile terminal, and data received from external for updating or driving one of applications installed in the mobile terminal.

10. The method according to claim 8, wherein the performing a web connection by using a virtual execution means further includes:
selecting a virtual execution means corresponding to a service subscribed by a user of the mobile terminal; and
performing the web connection through the selected virtual execution means.

11. The method according to claim 8, wherein the result of performing the web connection includes at least one of information on a home page screen of the web site corresponding to the link information, and reputation information on the web site corresponding to the link information.

12. The method according to claim 8, wherein the analyzing a result of performing the web connection and transmitting the result to the mobile terminal further includes:
detecting an application installed as a result of the web connection according to the link information;
when the application is detected, detecting a malicious behavior of the application;
analyzing the detected malicious behavior; and
transmitting a result of detecting the application, and a result of analyzing the detected malicious behavior to the mobile terminal.

13. The method according to claim 8, wherein the extracting link information corresponding to the web site and transmitting the link information to the external server further includes:
encrypting the link information by using preconfigured cipher information; and
transmitting the encrypted link information to the external server.
